(19) United States
(12) Patent Application Publication
(10) Pub. No.: US 2010/0067250 A1
(43) Pub. Date: Mar. 18, 2010

(54) SIDE-EMITTING BULB AND HEADLIGHT FOR A MOTOR VEHICLE

(75) Inventors: Matthias Daniel Epmeier, Aachen (DE); Sven Schellinger, Aachen (DE); Lingli Wang, Bad Kreuznach (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/595,635

(22) PCT Filed: Apr. 15, 2008
(86) PCT No.: PCT/IB08/51429

§ 371 Date: Oct. 13, 2009

(30) Foreign Application Priority Data
Apr. 19, 2007 (EP) 07106544.5

(51) Int. Cl. B60Q 1/00; H01J 5/48

(52) U.S. Cl. 362/539; 313/318.11

(57) ABSTRACT

The invention relates to a side-emitting bulb, comprising a light source (16) and at least one glass tube (20) which surrounds the light source, wherein the bulb has means for deflecting the emitted light in lateral directions. The invention also relates to a motor vehicle headlight comprising a reflector and a side-emitting bulb arranged in the reflector.

The invention relates to a side-emitting bulb according to the preamble of claim 1. The invention also relates to a headlight for a motor vehicle according to the preamble of claim 14.

Besides the incandescent bulbs which have already been used for a long time in the motor vehicle sector, discharge bulbs are increasingly also being used for motor vehicle lighting systems. In known discharge bulbs, a gas discharge which emits intensive light is generated between two electrodes in a closed discharge vessel.

A discharge bulb usually has a base, a burner with a discharge vessel, and an outer tube. The base serves for holding the burner and for positioning purposes, and also for the electrical contacting of the bulb in a headlight. The actual generation of light takes place in the discharge vessel. An outer tube made of glass is usually arranged around the discharge vessel. This outer tube serves to filter UV radiation out of the emitted light.

A motor vehicle headlight comprises a reflector and a bulb which protrudes through an opening into the interior of the reflector. The bulb is precisely positioned with its base in a mount of the reflector, so that the discharge vessel is arranged at a precisely known location. The reflector surface is illuminated by the emitted light. Depending on the shape of the reflector surface, a bundle of light from the headlight is formed, which is emitted in the forward direction.

In order to achieve maximum bundling of the emitted light, the reflector must be designed to be deep so that the light emitted from the light source at an angle of up to +/− 60 degrees is bundled. As a result, the reflector takes up a considerable amount of space.

The invention aims to alleviate this drawback. The object of the invention is to provide a side-emitting bulb which has a light emission characteristic with a smaller emission angle. According to the invention, this object is achieved by the features of the characterizing part of claim 1.

The invention provides a side-emitting bulb which has a light emission characteristic with a smaller emission angle. On account of the lateral emission characteristic, a more compact design of the reflector required for bundling the light is possible.

In one further development of the invention, the deflection means comprise optics fitted on the bulb for refracting and/or reflecting the emitted light. This gives rise to a smaller distance between the optics and the light source, as a result of which the efficiency of the optics is increased, in particular with regard to the light output that can be achieved.

Preferably, the means are fitted on the outer glass tube and/or are incorporated in the latter. This allows cost-effective manufacture of the optics. In one advantageous embodiment of the invention, the means are fitted on the discharge vessel and/or are incorporated in the latter. The distance from the light source is thereby further reduced, as a result of which the achievable light output is further increased.

In one further development of the invention, at least one protruding element is provided for deflecting emitted light. This permits a simple design possibility for deflecting the emitted light in the lateral direction. Preferably, the protruding element is cone-shaped, pyramid-shaped or plate-shaped.

In a further embodiment of the invention, the means comprise at least one TIR lens element. This permits targeted deflection of the emitted light radiation. As an alternative or in addition, the means may also comprise a Fresnel lens element and/or a mirroring element.

The object of the invention is also to provide a motor vehicle headlight which takes up a small amount of space. According to the invention, this object is achieved by the features of the characterizing part of claim 14.

The invention provides a motor vehicle headlight which takes up a small amount of space. By using a side-emitting bulb according to one of claims 1 to 13, it is possible to design a reflector which takes up only a small amount of space, as a result of which a headlight which takes up a smaller amount of space can be provided.

Other further developments and embodiments of the invention are specified in the further dependent claims. One example of embodiment of the invention is shown in the drawings and will be described in more detail below. In the drawings:

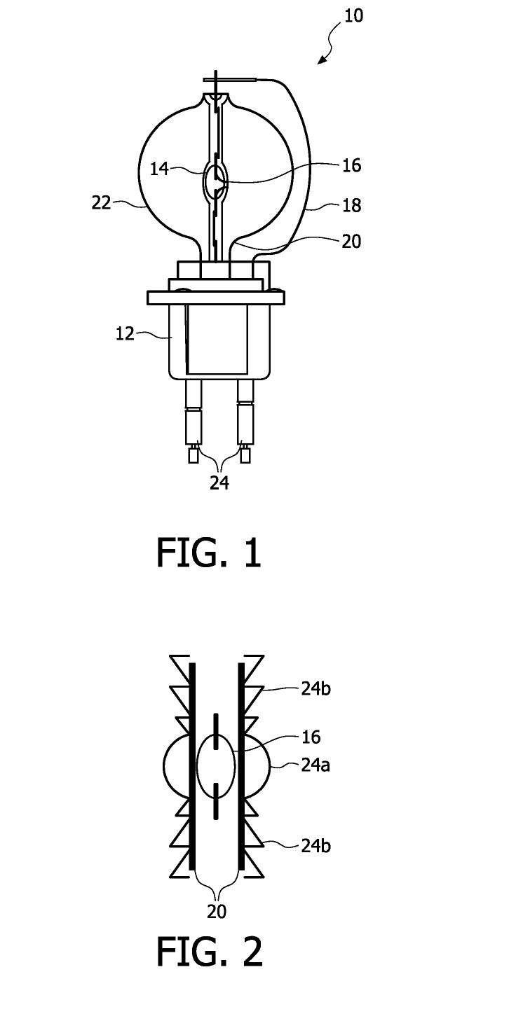

FIG. 1 shows a schematic diagram of a side-emitting discharge bulb;

FIG. 2 shows a schematic diagram of the optics of a side-emitting discharge bulb in a further embodiment;

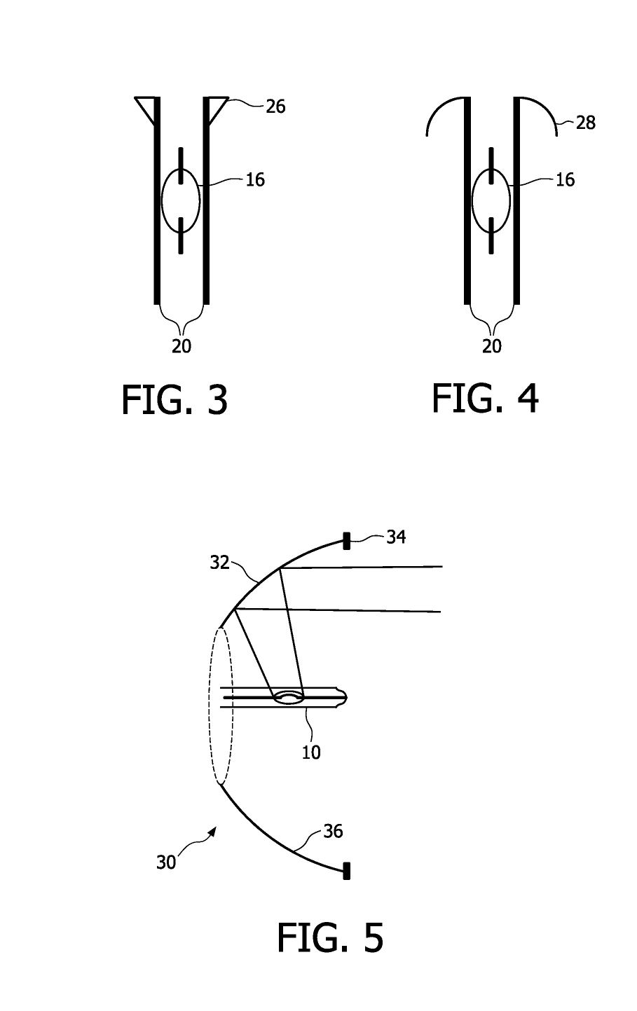

FIG. 3 shows a schematic diagram of the optics of a side-emitting discharge bulb in a further embodiment;

FIG. 4 shows a schematic diagram of the optics of a side-emitting discharge bulb in a different embodiment, and

FIG. 5 shows a view of a longitudinal section through an embodiment of a headlight according to the invention.

The side-emitting bulb designed as a discharge bulb 10 in the example of embodiment comprises a base 12, a burner 14 with a discharge vessel 16, and a return terminal 18.

The base 12 has electrical contacts which are connected via a lead-through and the return terminal 18 to electrodes of the discharge vessel 16. A discharge can thus be generated within the discharge vessel 16.

The discharge bulb 10 has an outer tube 20 around the burner 14. The outer tube 20 has a considerable curvature 22 over its periphery, which is designed in such a way that the emitted light is refracted in lateral directions. The outer tube 20 shaped in this way thus fulfils the function of a lens. The glass of the outer tube is doped in a manner known to the person skilled in the art so that good UV absorption is ensured.

In the example of embodiment shown in FIG. 2, the outer tube 20 is designed as a glass tube having an inner diameter which is only slightly larger than the outer diameter of the discharge vessel 16. Lens elements 24a, 24b are incorporated around the periphery of the outer tube 20. In the text below, “lens element” will be understood to mean a cohesive area of the bulb with a light-refractive and/or light-reflecting effect. At the level of the discharge vessel 16, a lens element 24a with an exclusively refractive effect is arranged around the periphery. Incorporated on both sides of the lens element 24a is a respective lens element 24b which is designed as a TIR (Total Internal Reflection) lens. By virtue of this arrangement, a rotationally symmetrical deflection of the emitted light is achieved, said light being deflected laterally in a defined manner within a defined angle range. The lens arrangement further permits a very narrow design of the discharge bulb 10. Alternatively, the lenses may also be fitted directly on or in the discharge vessel or may be incorporated in the latter, as a result of which the distance between the optics and the light source is further reduced. The effective strength of the lenses can thereby be further reduced.

In the example of embodiment shown in FIGS. 3 and 4, the deflection of the emitted light in lateral directions is brought about by outwardly protruding elements. In the example of embodiment shown in FIG. 3, a peripheral cone-shaped element 26 is arranged on the side of the discharge bulb 10 remote from the base. The cone-shaped element 26 is designed in such a way that a defined deflection of the emitted light in lateral directions is achieved. In this case, the cone-shaped element 26 is designed to be partially reflective. In the example of embodiment shown in FIG. 4, a plate-shaped element 28 is integrally formed around the periphery at the upper side of the discharge bulb 10. The plate-shaped element 28 is specularly reflective on its inner side and is shaped in such a way that the emitted light is deflected in defined lateral directions.

The above-described optical means for deflecting the emitted light in lateral directions represent just an example of a choice of optics that can be used. Besides TIR lenses, Fresnel lenses or simple refractive lenses, other design possibilities for the defined refraction and/or reflection of the emitted light are known to the person skilled in the art, and the use thereof also forms part of the teaching placed under protection.

FIG. 5 shows a longitudinal section through one embodiment of a headlight 30. The headlight 30 comprises a reflector 32 and the above-described side-emitting discharge bulb 10 which protrudes through a central opening of the reflector 32 into the interior of the reflector housing so that the discharge vessel is positioned at a predefined location in the interior of the reflector housing. To this end, the base 12 is received in a mount (not shown in any greater detail) of the reflector housing. From there, the discharge bulb 10 is also electrically contacted.

In the example of embodiment, the reflector 32 has an oval frame 34. The inner wall 36 of the reflector 32 is a curved surface. In the example of embodiment, however, this is not a parabolic surface but rather a specially shaped free surface. Such reflector shapes are also known to the person skilled in the art by the term “complex shape”. Such reflector shapes are calculated by numerical methods known to the person skilled in the art. The requirement here is to superpose and project images of the discharge positioned at a fixed location in such a way as to produce a bundle of light from the headlight which has a desired light distribution. Due to the side-emitting characteristic of the discharge bulb 10, the reflector housing of the reflector 32 has only a small depth. Furthermore, connections (not shown) for optical fibers for example for feeding light bands are provided on the reflector 32 of the headlight 30. Due to the side-emitting characteristic of the discharge bulb 10, these optical fibers are fed with particularly intensive light.

1. Side-emitting bulb, comprising:
a light source for emitting light,
at least one glass tube which surrounds the light source, and
means for laterally deflecting the emitted light comprising at least one TIR lens element for refracting and/or reflecting the emitted light and/or at least one protruding optical element for deflecting emitted light.

2. Side-emitting bulb according to claim 1, wherein the light source comprises a closed discharge vessel for generating an electrical discharge.

3. (canceled)

4. Side-emitting bulb according to claim 1, wherein the deflection means are fitted on and/or incorporated into the outer glass tube.

5-6. (canceled)

7. Side-emitting bulb according to claim 1, wherein the protruding element is cone-shaped.

8. Side-emitting bulb according to claim 1, wherein the protruding element is pyramid-shaped or plate-shaped.

9-11. (canceled)

12. Side-emitting bulb according to claim 1, wherein the means for deflecting the emitted light comprise at least one Fresnel lens element and/or at least one mirroring element.

13. (canceled)

14. Motor vehicle headlight comprising a reflector and a side-emitting bulb according to claim 1, arranged in the reflector.
